(19) United States
(12) Patent Application Publication
(10) Pub. No.: US 2004/0016446 A1
(43) Pub. Date: Jan. 29, 2004

(54) Apparatus and method for cleaning the magnetic head of a card reader

(76) Inventor: Frank Krancevic, (US)

Correspondence Address: Michael Roman, Suite 800, 885 West Georgia Street, Vancouver, BC, V6C 3H1, CA

(21) Appl. No.: 10/202,906

(22) Filed: Jul. 26, 2002

(51) Int. Cl. B08B 1/00; A47L 13/17

(52) U.S. Cl. 134/8; 15/104.94; 15/210.1

(57) ABSTRACT

An apparatus for cleaning the magnetic head of a card reader, particularly, a generally rectangular shaped semi-rigid card, wherein at least one aperture is sized and positioned on the apparatus to allow the magnetic head of a card reader to protrude into the aperture. The aperture is at least partially covered with an absorbent material which is bonded to the apparatus and may be presaturated with a cleaning solvent. As the apparatus passes through the card reader, the aperture covered by the semi absorbent material conforms to the entire convex surface of the magnetic head, and effectively removes particulate matter on the magnetic head. The apparatus, without the cleaning solvent, is then used to remove any remaining particulate matter raised by the cleaning solvent to prevent settling of residue.

### NOTICE REGARDING COPYRIGHTED MATERIAL

A portion of the disclosure of this patent document contains material which is subject to copyright protection. The copyright owner has no objection to the facsimile reproduction by anyone of the patent document or the patent disclosure as it appears in the public Patent Office file or records but otherwise reserves all copyright rights whatsoever.

### TECHNICAL FIELD

This invention relates to the cleaning of the magnetic heads used in magnetic strip card readers, more particularly, an apparatus which conforms to the shape of the magnetic head, allowing the entire convex surface of the magnetic head to be cleaned.

### BACKGROUND

In a society that values convenience and security, magnetic strip cards and magnetic strip card readers are used extensively. For example, retail and restaurant businesses accept credit cards and debit cards for cashless payment. Machines, traditionally coin operated, such as public telephones, parking meters, and vending machines, now accept magnetic strip cards, such as credit and debit cards, as a form of payment. Banking terminals allow individuals to access banking services at their convenience through the use of debit cards. Access control terminals provide security by restricting entry to residential and/or business complexes to holders of access cards. The applications for cards carrying data in magnetic strips continue to expand.

In all magnetic strip card applications, the data stored within the magnetic strip is read and processed by a magnetic head contained within the card reader. Typically, the card is either inserted or manually swiped through a slot of the card reader and/or is mechanically guided by rollers to enable direct contact between the magnetic strip and the magnetic head.

Card reader failures and errors are usually linked to dirty magnetic heads and/or poor maintenance. Card readers may become contaminated with magnetic oxides, dust, dirt, fingerprint oils, and other environmental contaminants which accumulate on the magnetic head. These contaminants, when left on the magnetic head, can result in processing errors, lost data and downtime, as well as increased wear on the magnetic heads.

Poor maintenance of magnetic heads is also associated with card reader failures and errors. One method of cleaning magnetic heads involves disassembling the card reader to expose the magnetic head and the rollers so that they may be cleaned using a soft material saturated with a cleaning solvent. The dismantling of the card reader and the amount of downtime required to clean the magnetic head using this method is highly inconvenient and impractical, particularly if the magnetic head requires daily cleaning due to heavy use.

Another conventional method for cleaning magnetic heads is to use a cleaning card. The typical cleaning card has a semi absorbent material bonded to both sides of the card and is saturated with a cleaning solvent and then stored in such fashion for use (i.e. presaturated) or saturated with a cleaning solvent immediately prior to use. The cleaning card is then inserted or swiped through the slot of a card reader to clean the magnetic head.

There are a number of cleaning cards disclosed in the art. For example, Rasza, U.S. Pat. No. 5,277,226 discloses a cleaning card made of spun-bonded polyester material which absorbs a wide range of cleaning solvents. Eyler, U.S. Pat. Nos. 5,525,417 and 5,824,611 disclose cleaning cards with an abrasive material mechanically bonded to one side of the cleaning card and a soft material mechanically bonded to the other side of the cleaning card. Michael et al., U.S. Pat. No. 6,210,490 discloses a cleaning card made of a rigid absorbent material, presaturated with a cleaning solvent. The cleaning card has three holes which scrub the sides of the magnetic head as it protrudes through.

None of the cleaning cards currently available sufficiently clean magnetic heads because they are do not conform to the entire convex surface of the magnetic heads. Furthermore, the cleaning cards do not prevent particulate matter raised by the cleaning solution from settling back on the magnetic head once the cleaning solution evaporates.

It is an object of the present invention to provide a cleaning card that can fully clean and dry the entire convex surface of the magnetic head of a card reader in a efficient and convenient manner.

### SUMMARY OF THE INVENTION

The present invention is an apparatus and a method for cleaning the magnetic head of a card reader. The apparatus is comprised of a semi-rigid card with at least one aperture positioned to allow the magnetic head to protrude into the aperture. An absorbent material, which covers the aperture, is bonded to at least one side of the semi-rigid card. The absorbent material may be presaturated with a cleaning solvent so that the apparatus is ready for immediate use. The method of cleaning the magnetic head includes sliding the card that has been saturated with cleaning solvent through the card reader followed by sliding a card that is not saturated with cleaning solvent through the card reader to dry the magnetic head.

### BRIEF DESCRIPTION OF FIGURES

Further objects, features and advantages of the present invention will become more readily apparent to those skilled in the art from the following description of the invention when taken in conjunction with the accompanying drawings, in which:

FIG. 1 is a side view of a cleaning card described in the prior art;

FIG. 2 is a side view of the preferred embodiment of an apparatus for cleaning a magnetic head of a card reader according to the invention;

FIG. 3 is a cross sectional front view thereof; and

FIGS. 4a to 4d are top cross sectional views of the card in use cleaning a magnetic head.

### DETAILED DESCRIPTION OF PREFERRED EMBODIMENTS

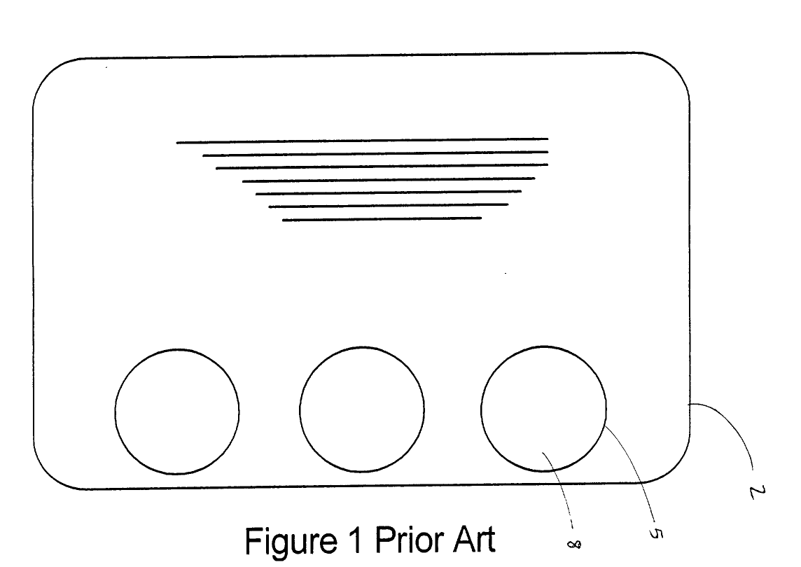

A typical prior art cleaning card 2, as shown in FIG. 1 is credit card sized. By manually guiding cleaning card 2, which is saturated with cleaning solvent, through a card reader, the magnetic head is cleaned by allowing the edges 5 of the holes 8 to rub the sides of the magnetic head as cleaning card 2 passes through the reader. However, cleaning card 2 fails to adequately clean the magnetic head because it does not conform to the convex surface of the magnetic head. Furthermore, particulate matter raised by the cleaning solvent on cleaning card 2 is not removed and may settle back on the magnetic head once the cleaning solvent has evaporated.

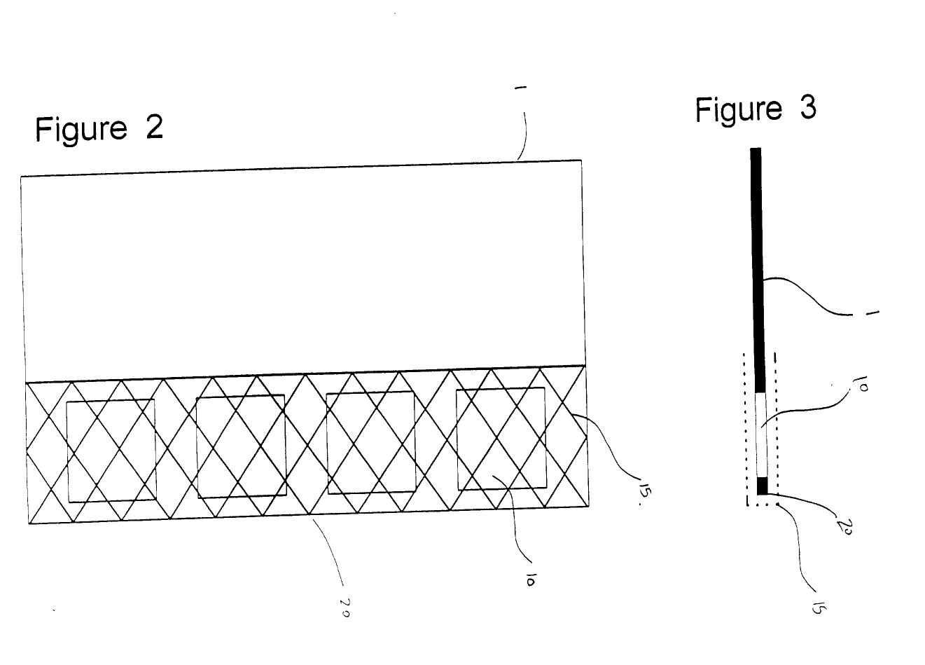

As illustrated in FIG. 2, a cleaning card 1 according to the invention includes apertures 10 and absorbent material 15. Absorbent material 15, which covers apertures 10, is typically bonded to both sides of cleaning card 1. In alternative embodiments of the invention, absorbent material 15 may be bonded only to a single side of card 1. Also, if apertures 10 are sufficiently large, absorbent material 15 may not need to completely cover apertures 10.

Cleaning card 1 is made of a semi-rigid material such as cardboard or plastic. In a preferred embodiment, cleaning card 1 is made of a plastic material such as polyvinyl chloride (PVC), polyethylene terepthalate (PET), acrylonitrile buadien styrene (ABS), polycaronate (PC), or a mixture of such plastic materials. Cleaning card 1 can be any shape and size as long as it is capable of being swiped through or inserted in the slot of a card reader. As illustrated in FIG. 2, the preferred shape of cleaning card 1 is generally rectangular with dimensions substantially similar to that of a credit card. Such preferred dimensions of cleaning card 1 are 3.38 inches in length, 2.13 inches in height, and 0.3 inches in width.

Cleaning card 1 has at least one aperture 10 positioned to enable the magnetic head of a card reader to protrude into aperture 10 when cleaning card 1 is swiped through or inserted in the slot of a card reader. Typically, aperture 10 is positioned 0.13 inches from bottom edge 20. As illustrated in FIG. 2, cleaning card 1 typically has four apertures 10 spaced apart from each other. In this embodiment, each aperture 10 is 0.25 inches apart. Aperture 10 may be of any shape, such as circular or triangular, as long as the magnetic head of a card reader can protrude into aperture 10. Typically, aperture 10 is generally rectangular in shape and has the dimensions of 0.53 inches in width and 0.62 inches in height.

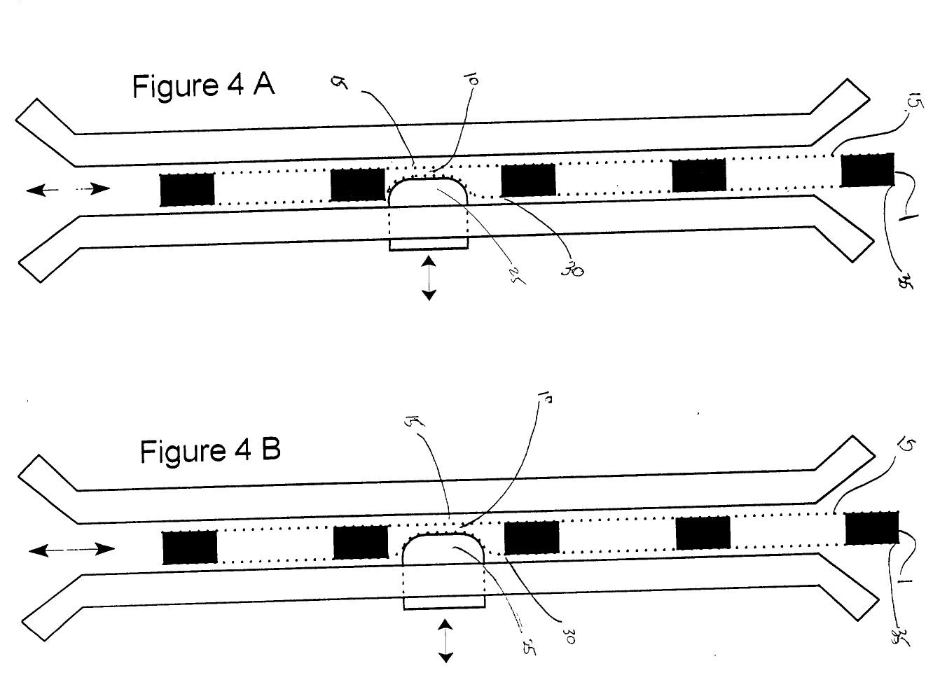

Absorbent material 15 can be made of any mildly abrasive absorbent material such as rayon or cotton. The preferred material for the present invention is a static free non-woven polyester with a preferred weight of 47.9 ounces per yard. Absorbent material 15 at least partially covers aperture 10 and is bonded to at least one side of cleaning card 1. Preferably, absorbent material 15 covers aperture 10 completely and is bonded to both sides of cleaning card 1. In the preferred embodiment, absorbent material 15 wraps around bottom edge 20 and is bonded to both sides of cleaning card 1, as best seen in FIG. 3. Any adhesive means can be used to bond absorbent material 15 to cleaning card 1, but the preferred means is by use of a polyethylene adhesive. Absorbent material 15 can be bonded anywhere on both sides of cleaning card 1 as long as absorbent material 15 at least partially covers aperture 10 such that material 15 aligns with magnetic head 25 when cleaning card 1 is in use. Typically, absorbent material 15 is bonded one inch from bottom edge 20 on both sides of cleaning card 1, as seen in FIG. 2 and FIG. 3.

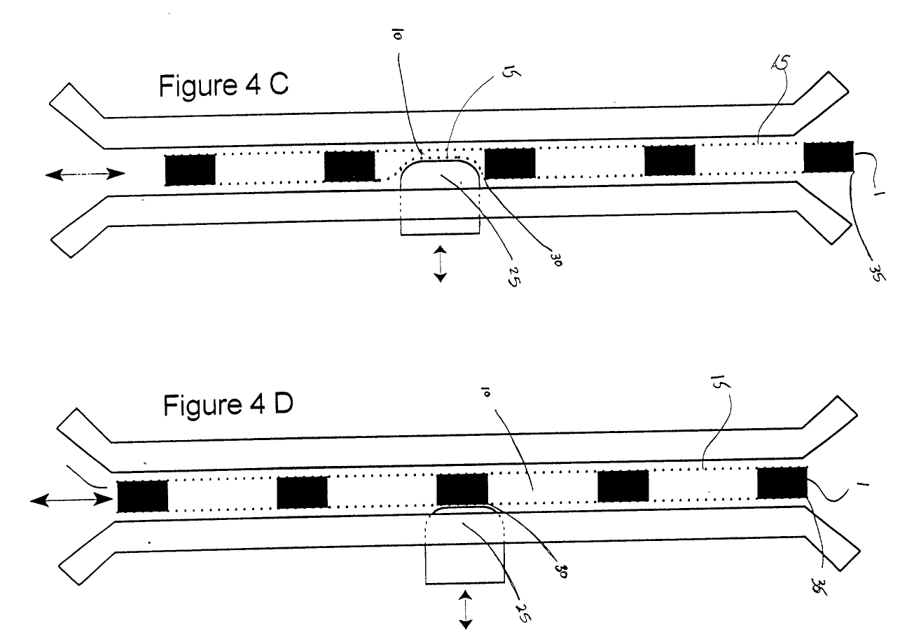

To use cleaning card 1 to clean magnetic head 25 of a card reader, cleaning card 1 is simply swiped through or inserted in the slot of a card reader in the same manner as a magnetic strip card. As best seen in FIG. 4C, when magnetic head 25 passes into aperture 10 covered by absorbent material 15, absorbent material 15 is pushed into aperture 10 and conforms to the entire convex surface of magnetic head 25. Absorbent material 15, which is saturated with a cleaning solvent, will thereby completely clean magnetic head 25. In the preferred embodiment, magnetic head 25 protrudes into four apertures 10 covered by absorbent material 15, effectively cleaning the entire convex surface of magnetic head 25.

Absorbent material 15 is typically saturated with a cleaning solvent such as isopropylene alcohol, trichlorotrifluoroethane, or decafluoropentane. Absorbent material 15 may be presaturated with a cleaning solvent and stored in such a fashion for later use or it may be manually saturated with cleaning solvent just prior to use. Absorbent material 15 may be presaturated and stored in a tear-away bag for use, thereby not requiring the user to have cleaning solvents on hand. In the preferred embodiment, because absorbent material 15 does not cover the entire cleaning card 1, when in use, if the user grips the portion of the card not covered by absorbent material 15, the cleaning solvent does not directly contact the skin of the user's hands.

Aside from cleaning the convex surface of magnetic head 25, cleaning card 1 also cleans the sides of magnetic head 25. As best seen in FIGS. 4A to 4D, the edges 30 of apertures 10 rub against magnetic head 25 as it moves in and out of the apertures 10 covered by absorbent material 15. The leading edge 35 of card 1 and edges 30 of apertures 10 covered by absorbent material 15 provide a rubbing action against the sides of magnetic head 25, effectively removing the dirt as cleaning card 1 passes through the card reader. In the preferred embodiment, magnetic head 25 rubs against four edges 30 of apertures 10 covered by material 15 and leading edge 35, effectively cleaning the sides of magnetic head 25. In an alternative embodiment, cleaning card 1 can be swiped through the slot of a card reader in both directions (i.e. in a bi-directional manner), thereby cleaning both sides of magnetic head 25.

The use of cleaning card 1 also effectively cleans the rollers and the slot of a card reader because cleaning card 1 is in contact with the slot and the rollers when cleaning card 1 is guided through the card reader.

In another embodiment of cleaning card 1, absorbent material 15 is not saturated with cleaning solvent. A dry cleaning card, (i.e. a cleaning card 1 that has not been presaturated with cleaning solvent) can be used to dry the magnetic head after using a cleaning card saturated with cleaning solvent. The dry cleaning card is used and works exactly the same way as the saturated cleaning card. The dry absorbent material 15 effectively removes any remaining particulate debris raised by the cleaning solvent and prevents any residual dirt from settling back upon the magnetic head.

While the principles of the invention have now been made clear in the illustrated embodiments, it will be immediately obvious to those skilled in the art that many modifications may be made of structure, arrangements, and algorithms used in the practice of the invention, and otherwise, which are particularly adapted for specific environments and operational requirements, without departing from those principles. The claims are therefore intended to cover and embrace such modifications within the limits only of the true spirit and scope of the invention.

What is claimed is:

1. An apparatus for cleaning a magnetic head of a card reader, comprising:
(a) a semi-rigid card having a first side;
(b) at least one aperture on said semi-rigid card positioned to allow said magnetic head to protrude into said aperture; and
(c) an absorbent material bonded to said first side of said semi-rigid card wherein said absorbent material at least partially covers said aperture.

2. The apparatus for cleaning a magnetic head of a card reader of claim 1, wherein said semi-rigid card is made of plastic.

3. The apparatus for cleaning a magnetic head of a card reader of claim 2, wherein said semi-rigid card is substantially the size of a credit card.

4. The apparatus for cleaning a magnetic head of a card reader of claim 3, wherein said aperture at least conforms in length and width with said magnetic head.

5. The apparatus for cleaning a magnetic head of a card reader of claim 4, wherein said semi-rigid card has four apertures positioned to allow said magnetic head to protrude into said apertures.

6. The apparatus for cleaning a magnetic head of a card reader of claim 5, wherein said apertures are substantially rectangular with rounded corners.

7. The apparatus for cleaning a magnetic head of a card reader of claim 6, wherein said absorbent material is a static free non-woven polyester.

8. The apparatus for cleaning a magnetic head of a card reader of claim 7, wherein said absorbent material is substantially saturated with a cleaning solvent before use.

9. The apparatus for cleaning a magnetic head of a card reader of claim 8, wherein said absorbent material is bonded to said first side of said semi-rigid card using a polyethylene adhesive.

10. The apparatus for cleaning a magnetic head of a card reader of claim 9, wherein said absorbent material is further bonded to a second side of said semi-rigid card.

11. The apparatus for cleaning a magnetic head of a card reader of claim 8, wherein said absorbent material is bonded to said first side, wrapped around a first edge of said semi-rigid card and bonded to a second side of said semi-rigid card.

12. A method of cleaning a magnetic head of a card reader comprising the steps of:
(a) providing a card for cleaning a magnetic head of a card reader comprising:
(i) a first semi-rigid card having a first side;
(ii) at least one aperture on said first semi-rigid card positioned to allow said magnetic head to protrude into said aperture; and
(iii) an absorbent material bonded to a first side of said first semi-rigid card wherein said absorbent material at least partially covers said aperture; and
(b) sliding said first semi-rigid card through said magnetic card reader, wherein said absorbent material is saturated with a cleaning solvent.

13. The method of cleaning a magnetic head of a card reader of claim 12, wherein a second semi-rigid card not saturated with cleaning solvent is swiped through a magnetic card reader.

14. The method of cleaning a magnetic head of a card reader of claim 13, wherein said first semi-rigid card is made of plastic.

15. The method of cleaning a magnetic head of a card reader of claim 14, wherein said first semi-rigid card is substantially the size of a credit card.

16. The method of cleaning a magnetic head of a card reader of claim 15 wherein said aperture at least conforms in length and width with said magnetic head.

17. The method of cleaning a magnetic head of a card reader of claim 16, wherein said first semi-rigid card has four apertures positioned to allow said magnetic head to protrude into said aperture.

18. The method of cleaning a magnetic head of a card reader of claim 17, wherein said four apertures are substantially rectangular with rounded corners.

19. The method of cleaning a magnetic head of a card reader of claim 18, wherein said semi absorbent material is a static free non-woven polyester.

20. The method of cleaning a magnetic head of a card reader of claim 19, wherein said semi absorbent material is bonded to said first side using a polyethylene adhesive at a position that at least partially covers said apertures and aligns with said magnetic head.
